(19) United States
(12) Patent Application Publication
(10) Pub. No.: US 2010/0199209 A1
(43) Pub. Date: Aug. 5, 2010

(54) ITEM SETTING APPARATUS, CONTROL METHOD AND CONTROL PROGRAM FOR THE SAME

(75) Inventors: Chie SUEOKA, Tokyo (JP); Seiji Harada, Tokyo (JP); Rei Yokoyama, Tokyo (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/685,144

(22) Filed: Jan. 11, 2010

(30) Foreign Application Priority Data
Jan. 20, 2009 (JP) 2009-010041

(51) Int. Cl. G06F 3/048

(52) U.S. Cl. 715/777

(57) ABSTRACT

An item setting apparatus for changing over a screen corresponding to a desired tab by selecting the desired tab from plural tabs and setting items displayed on the screen based on a user's operation, comprises an item information holding section to hold item information about indication of items of plural tabs having plural items; a group information holding section to separate items into plural groups and hold group information about that to which group each item belongs; a display item editing section to edit items displayed on a screen of a tab; and a tab display control section to control to display items correctively by a group unit on a screen of a tab selected by a user by using the group information.

This application is based on Japanese Patent Application No. 2009-010041 filed on Jan. 20, 2009, in Japanese Patent Office, the entire content of which is hereby incorporated by reference.

### BACKGROUND

The present invention relates to an item setting apparatus, its control method and control program. Especially, the present invention relates to an item setting apparatus, its control approach and control program for conducting setting based on a user's operation for items displayed on a screen which can be changed over by the selection of a desired tab among plural tabs.

In the case where a user executes printing with a printer in a printing system, the user sets a desired setting value of each setting item so as to set printing conditions by using control programs called a printer driver on a PC (personal computer), and makes a printer execute printing. The number of setting items in a printer driver tends to increase as various printing conditions can be set with the improvement of the performance of a printer.

Then, plural setting items are classified into relevant functions and are related with respective tabs in such a way that the visibility and operability of a printer driver are improved. Accordingly, when a user sets desired printing conditions, the user changes over an operation screen by selecting a tab so as to display a desired setting item, and sets (changes) the setting item.

Therefore, in the case where a user is required to set printing conditions by changing plural setting items related with different tabs, the setting work of the printing conditions becomes complicate.

In such a background, a technique is proposed to allow a user to change freely the design of a screen such that the user can replace freely setting items, which are different originally in attribution and cannot be replaced with one another, as intended setting item and design a screen so as to include setting items different in attribution (refer to Japanese Patent Unexamined Publication No. 11-53137).

However, there is a case where a setting item to manage one function on a screen is structured with plural items (called “control”). For this reason, it is supposed that if each of the plural items is handled independently one by one at the time of editing arrangement of setting items on a screen, a setting item to manage a function to accomplish a meaning exactly cannot be formed depending on an arrangement of the plural items.

For example, there is a setting item to manage a function for setting the number of print copies, and it is assumed that the setting item is composed of two items of “a static text written as “the number of copies”” and “spin box for setting the number of copies” on a screen. If these two items are handled independently, it becomes possible to arrange only a spin box on the screen. However, in this case, since a text to explain the spin box does not exist on the screen, a problem arises such that it becomes difficult for a user to understand that a spin box manages what function.

### SUMMARY

The present invention has achieved in view of the above-mentioned problems, and an object of the present invention is to provide an item setting apparatus, its control method and control program that can prevent items (control) as structural elements of a setting item to manage one function from being handled separately respectively.

To achieve the abovementioned object, an item setting apparatus reflecting one aspect of the present invention comprises:

an item information holding section to hold item information about indication of items of plural tabs having plural items;

a group information holding section to separate items into plural groups and hold group information about that to which group each item belongs;

a display item editing section to edit items displayed on a screen of a tab; and

a tab display control section to control to display items correctively by a group unit on a screen of a tab selected by a user by using the group information.

### BRIEF DESCRIPTION OF THE DRAWINGS

FIG. 1 is a block diagram showing an entire configuration of a printing system according to one embodiment of the present invention.

FIG. 2 is a block diagram showing a structure of a PC shown in FIG. 1.

FIG. 3 is a diagram showing a basic configuration of a printer driver.

FIG. 4 is a flowchart showing procedures of display processing for a print setting screen.

FIG. 5 is a diagram showing an example of item information.

FIG. 6 is an illustration showing an example of a screen of a fixed tab.

FIG. 7 is a diagram showing an example of an editable list.

FIG. 8 is a diagram showing an example of a group information list.

FIG. 9 is a diagram showing information on each setting item with a table.

FIG. 10 is an illustration showing an example of an editing screen.

FIG. 11 is an illustration for explaining a case where editing on screen is directly instructed on a screen of an editable tab.

FIG. 12 is an illustration for explaining a case where editing on a screen of an editable tab is instructed on a screen of a fixed tab.

FIG. 13 is a diagram showing an example of a display item list.

FIG. 14 is a flowchart showing procedures of display processing for a screen of an editable tab is shown.

FIG. 15 is a diagram showing an example of a displayed information table.

FIG. 16 is a diagram showing an example of a display item list after edit.

FIG. 17 is an illustration showing an example of a screen of an editable tab on which displayed in the condition of the display item list shown in FIG. 13.

FIG. 18 is an illustration showing an example of a screen of an editable tab on which the condition that the display item list shown in FIG. 15 has been edited is displayed after the condition of the display item list shown in FIG. 13 has been displayed.

### DETAILED DESCRIPTION OF THE PREFERRED EMBODIMENT

Hereafter, embodiments of the present invention will be described in detail with reference to the drawings. However, the present invention is not limited to these embodiments.

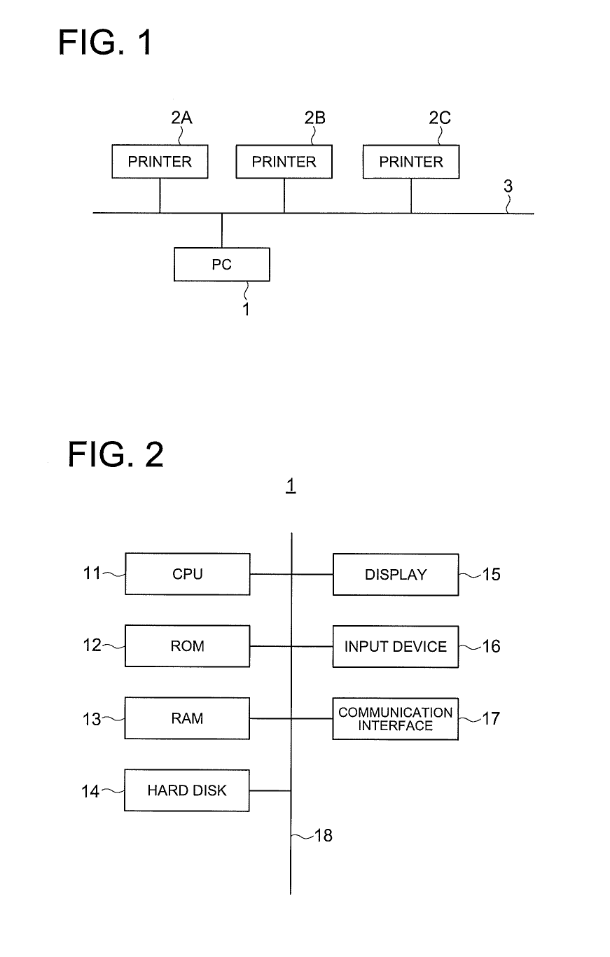

FIG. 1 is a block diagram showing the entire configuration of a printing system according to one embodiment of the present invention.

As shown in FIG. 1, the printing system according to this embodiment is equipped with a PC (personal computer) 1, and printers 2A, 2B and 2C which are connected through a network 3 so as to be able to communicate with each other. The type of devices and the number of devices connected to the network 3 are not limited to the example shown in FIG. 1. Further, the PC 1 may be directly connected to the printers 2A, 2B, and 2C between them through the network 3 (local connection) without the connection through the network 3.

The network 3 is configured by various kinds of networks, for example, such as LAN in which computers and network devices are connected to each other in accordance with specifications, such as Ethernet (registered trademark), Token Ring, and FDDI, and WAN in which LANs are connected with each other through exclusive lines.

FIG. 2 is a block diagram showing the structure of the PC 1 shown in FIG. 1. The PC 1 is equipped with a CPU 11, a ROM 12, a RAM 13, a hard disc 14, a display 15, an input device 16, and a communication interface 17, and these units are connected mutually for exchanging signals through a bus 18.

The CPU 11 executes the control of the above units and various kinds of arithmetic processing in accordance with programs. The ROM 12 stores various programs and various data. The RAM 13 memorizes programs and data temporarily as a working area. The hard disc 14 stores various programs including A hard disc 14 stores the various programs and various data containing an operating system (OS) and various data.

The display 15 is a CRT, LCD or the like and displays various kinds of information. The input device 16 includes pointing devices, such as a mouse, and a keyboard, and is used in order to perform various kinds of inputs.

The communication interface 17 is an interface for communicating with other devices, such as the printer 2A, 2B, and 2C, through the network 3. As the communication interface 17, in addition to network interfaces in accordance with specifications, such as Ethernet (registered trademark), Token Ring and FDDI; various local connection interfaces, such as serial interfaces, such as USB and IEEE 1394; a parallel interface, such as SCSI and IEEE1284; wireless communication interfaces, such as Bluetooth (registered trademark), IEEE802.11, HomeRF, and IrDA; and telephone line interfaces for connecting with telephone lines, and the like may be used.

In the hard disc 14, a document file preparation application and a printer driver are installed. The printer driver sets up printing conditions based on an operation of a user by the use of a print setting screen mentioned later, and produces a print job with a format capable of being processed by the printer 2A, 2B, and 2C based on a document file transferred from the document file preparation application.

The PC 1 may include structural components other than the above structure components, or may not include a part of the above structure components.

The printers 2A, 2B, and 2C receive the print job produced by the PC 1 through the network 3 respectively, and perform a printing process in accordance with the print job.

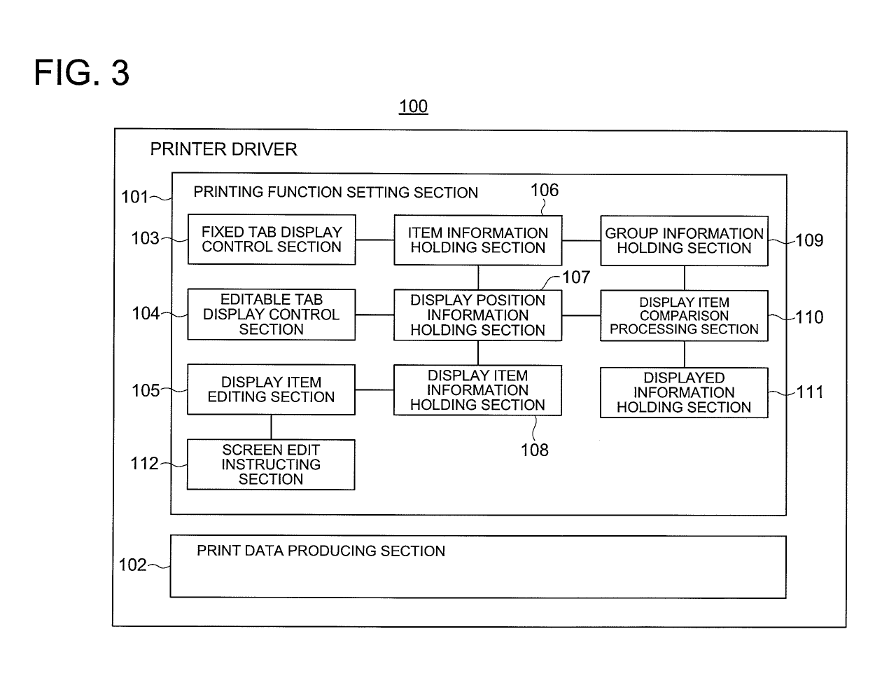

FIG. 3 is a schematic diagram showing a basic constitution of a printer driver.

The printer driver 100 is software that is installed in an operating system (OS) of the PC 1 being a host computer and produces a print job. The printer driver 100 can execute settings for utilizing the functions mounted in a corresponding printer through a user interface, produce a print job in accordance with the settings, and transmit the print job to the printer.

The printer driver 100 has a printing function setting section 101 and a print data producing section 102.

The printing function setting section 101 provides a screen (GUI) where a user can set desired printing conditions. On a screen displayed by the printer driver 100 of this embodiment, a fixed tab and a editable tab are displayed so as to be selectable by a user. The fixed tab holds fixed items, and the display positions of the items are fixed. In the editable tab having items, the items can be edited, and the displayed positions of the items are editable. When the editable tab is selected by a user, a screen (a screen of the editable tab) related to the editable tab is displayed, and when the fixed tab is selected by a user, a screen (a screen of the fixed tab) related with the fixed tab is displayed. The information set on these screens is transferred to the print data producing section 102.

The print data producing section 102 produces a print job with a format capable of being processed by printers 2A to 2C based on a document file created by application software installed in the operating system (OS).

As shown in FIG. 3, the printing function setting section 101 includes an item information holding section 106, a fixed tab display control section 103, a display item information holding section 108, the display position information holding section 107, a displayed information holding section 111, a display item comparison processing section 110, an editable tab display control section 104, a display item editing section 105, a screen edition instructing section 112, and a group information holding section 109.

The item information holding section 106 holds item information regarding the display of items registered in the fixed tab. Concretely, item information is information, such as ID, type (a text, a radio button, a check box, an image, etc.), a display position (coordinates), a size (lengthwise and widthwise sizes) of a display region, display character strings, etc. with regard to each item (alternatively called “control”).

The fixed tab display control section 103 reads item information of a fixed tab, and controls indication on the screen of a specific fixed tab.

The display item information holding section 108 holds display item information with regard to which items to be displayed on the screen of the editable tab among the items held by the fixed tab.

The display position information holding section 107 holds display position information with regard to the display positions of the items to be displayed on the screen of the editable tab.

The displayed item information holding section 111 holds displayed item information with regard to which items having been displayed on which positions on the screen of the editable tab.

The display item comparison processing section 110 compares the display item information with the displayed item information, and determines a processing method for displaying the screen of the editable tab based on the comparison result.

The editable tab display control section 104 controls displaying the screen of the editable tab.

The display item editing section 105 conducts editing such as adding, shifting and deleting with regard to items displayed on the screen of the editable tab. That is, concretely, the display item editing section 105 edits items and display positions displayed on the screen of the editable tab.

The screen edition instructing section 112 receives an instruction from a user with regard to the edition for the items displayed on the screen of the editable tab. Then, when the screen edition instructing section 112 receives a command to change items and display positions to be displayed on the screen of the editable tab from a user, the screen edition instructing section 112 gives an instruction to edit the screen to the display item editing section 105.

The group information holding section 109 holds group information which indicates each of all items displayed by the printer driver to belong to which group of setting items (function). Here, the setting items are composed of plural items (controls).

The printing function setting section 101 and the print data producing section 102 perform their functions when the CPU 11 reads out programs memorized in the hard disc 14 onto the RAM 13 and executes the programs. The item information holding section 106, the display item information holding section 108, the display position information holding section 107, and the group information holding section 109 are assigned with a predetermined storage region respectively.

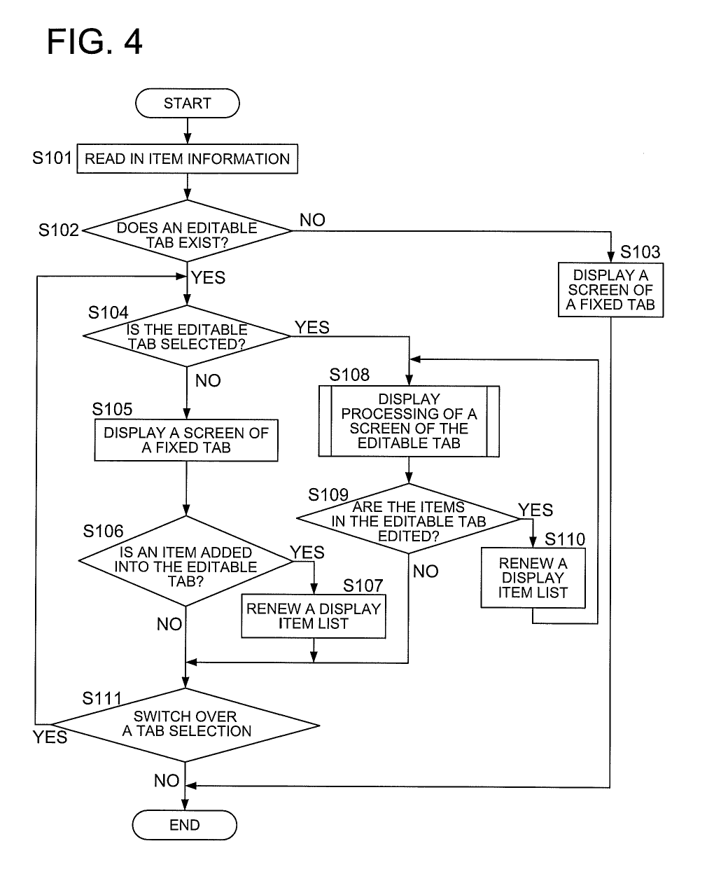

Next, with reference to FIG. 4, the actions of the printing function setting section 101 will be explained.

FIG. 4 is a flow chart which shows the procedures of display processing of a print setting screen.

First, item information of a fixed tab is read in (S101).

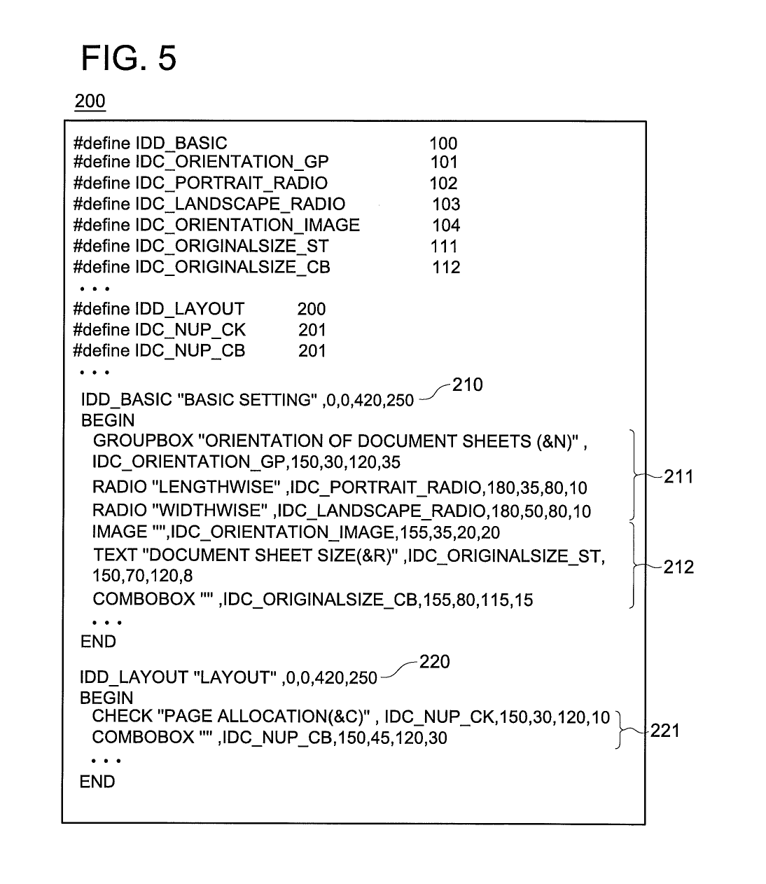

FIG. 5 shows an example of item information. In FIG. 5, “basic setting” tab information 210 and “layout” tab information 220 are exemplified as a part of item information. Further, the “basic setting” tab information 210 includes “orientation of document sheets” information 211 and “document sheet size” information 212, and the “layout” tab information 220 includes “page allocation” information 221.

Successively, whether an editable tab exists is judged (S102).

The setting of existence or nonexistence of an editable tab may be conducted not only at the time of development of a printer driver but by a user (or administrator). In the case that an editable tab was set to be nonexistence at the time of development of a printer driver, the printer driver is made a printer driver only with a fixed tab (the same as an ordinary printer driver). Further, in a printer driver having an editable tab, when a user sets up it as no editable tab, the editable tab is not displayed on a screen.

In the case that an editable tab does not exist (S102: NO), the screen of a fixed tab is displayed based on the read-in item information (S103).

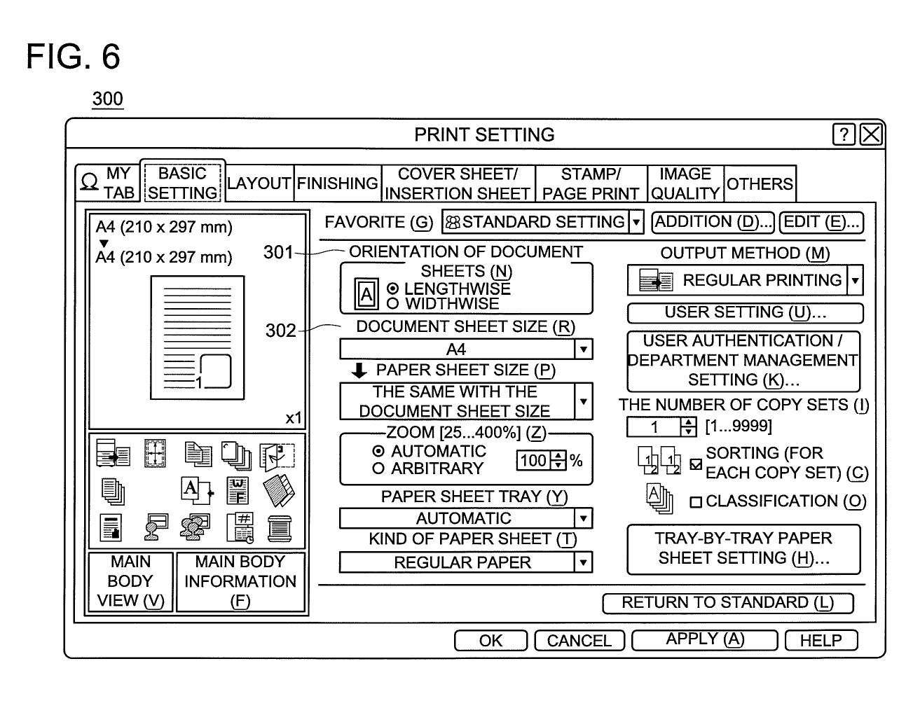

In the case that an editable tab exists (S102: YES), whether the editable tab (in FIG. 6, displayed as “My tab”) is selected is judged (S104).

In the printer driver 100 of this embodiment, in consideration of convenience, an editable tab is set to be displayed first at the time of start-up. However, it is also possible to set a fixed tab to be displayed first.

In the case that an editable tab is not selected and a fixed tab is selected (S104: NO), the screen of a fixed tab is displayed by the use of the read-in item information (S105).

FIG. 6 shows an example of a screen 300 of a fixed tab.

In FIG. 6, the screen of the basic setting tab is displayed in accordance with the “basic setting” tab information 210 of the item information 200 (refer to FIG. 5). With regard to each setting item, “orientation of document sheets” 301 is displayed in accordance with the “orientation of document sheets” information 211 in the item information 200, and the “document sheet size” 302 is displayed in accordance with “document sheet size” information 212 in the item information 200.

In the case that the editable tab is selected (S104: YES), the display processing for the screen of an editable tab is conducted (5108). The screen of an editable tab is collectively displayed by a group unit. The details of display processing of the screen of this editable tab will be mentioned later.

At Step S109, whether there was any operation of an user for editing items to be registered into an editable tab, is judged.

In the case that the screen of an editable tab is ended without editing items of an editable tab (S109: NO), whether there was any changeover of a tab selection by a user, is judged (S111).

In the case that a tab selection has been changed over (S111: YES), the flow returns to the process of S104.

In the case that a tab selection has not been changed over (S111: NO), the process of FIG. 4 is ended by an operation of an user for the completion of setting, the cancellation of setting, or a printing start.

On the other hand, in the case that there is an editable tab, items to be displayed on the screen of an editable tab can be added or edited by being registered in an editable tab (S106, S109).

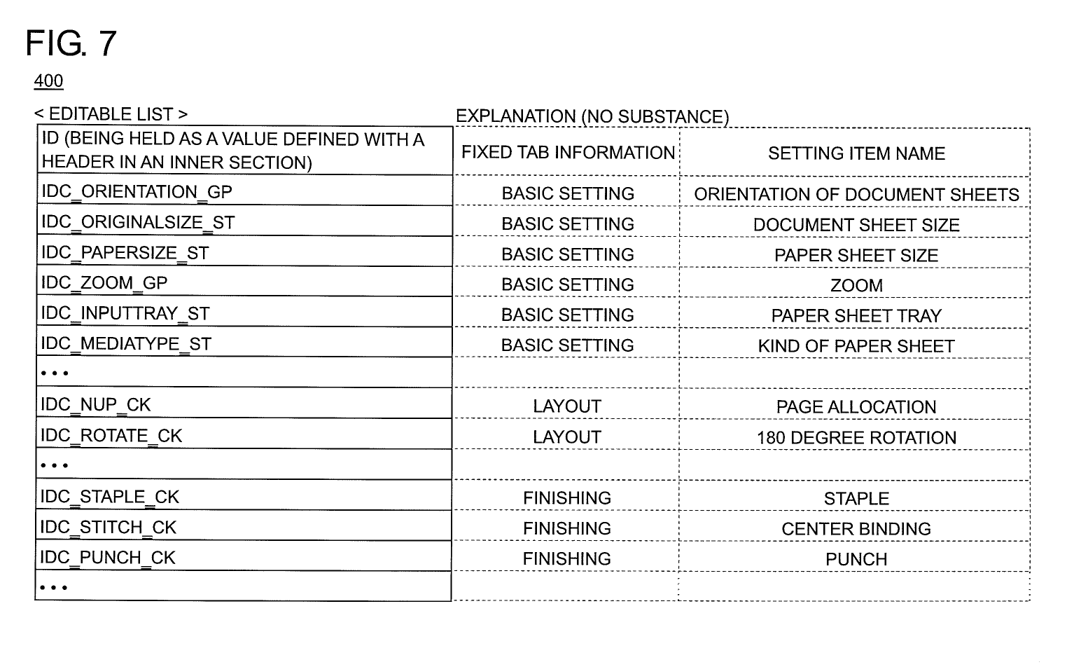

FIG. 7 shows an example of lists (editable list) of all items that can be registered in an editable tab. In this editable list 400, items (paper sheet view, etc.) common to all tabs and items exclusive for fixed tabs are no included. The description within a dashed line frame shown in the right side of FIG. 7 is prepared only for explanation, and substantive data do not exist in it (the description within a dashed line frame in the following drawings is also the same).

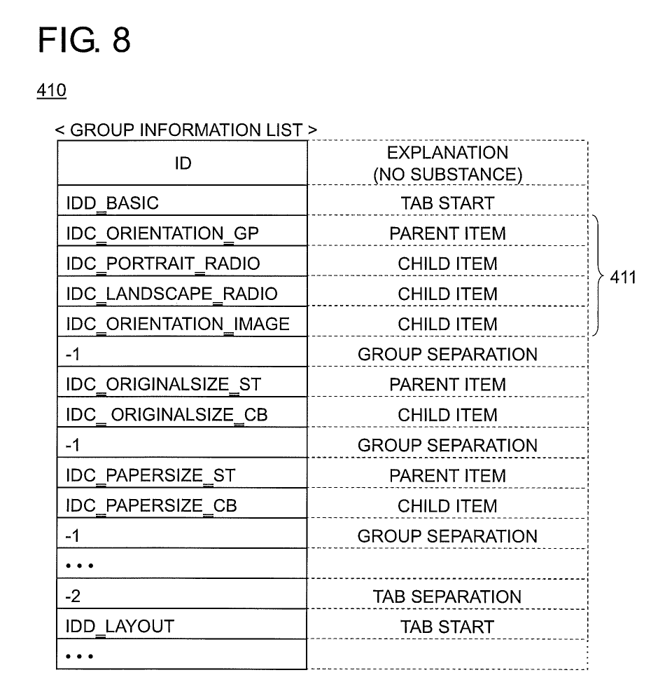

FIG. 8 shows an example of lists (group information lists) indicating the group information that which group of setting items each of plural items (control) belongs to. For example, the setting item called “orientation of document sheets” 301 (refer to FIG. 6) is composed of plural items of a group box, two radio buttons and an image as shown with the reference sign “411” in the group information list 410 of FIG. 8. That is, it can be said that one setting item is composed of a group of plural items. In this way, in order to treat plural items having cohesiveness in function as a group, in this embodiment, an item representing a group, i.e., a group's parent item, is determined, and the setting item is treated as the group unit by the use of the parent item. For example, in the setting item of “orientation of document sheets” 301 in FIG. 6, a ““orientation of document sheets” group box” is a parent item, and in the setting item of “document sheet size” 302, ““document sheet size” text” is a parent item (refer to FIG. 5).

In the following explanation, the name (ID is described by the parent item) of the setting item as a group is described. In this case, all items in the group are simultaneously processed. The group information list 410 may be structured to be incorporated in the above-mentioned item information 200 or the editable list 400.

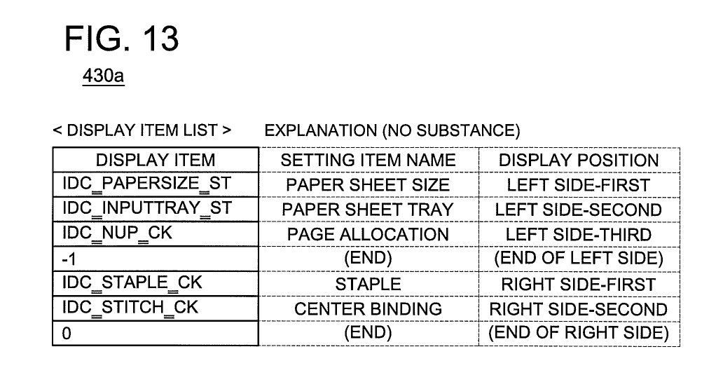

In the case that it is judged that there was an operation of a user for editing an item to be registered in an editable tab in Step S109 (S109: YES), a display item list is renewed (S110) and the flow returns to Step S108. The display item list is a list of display item information indicating that which items among the items held by a fixed tab are to be displayed on the screen of an editable tab (refer to FIG. 13).

At Step S106, whether there was any operation of a user for adding items to be registered into an editable tab, is judged. In the case that it is judged that there is no operation of a user for adding items to be registered into an editable tab (S106: NO), the flow proceeds to Step S111.

In the case that it is judged that there was an operation of a user for adding items to be registered into an editable tab in step S106 (S106: YES), a display item list is renewed (S107), and the flow proceeds to step S111.

As a method of editing items to be displayed on the screen of an editable tab and their display positions, there are a method (a) of editing while displaying an editing screen, and a method (b) of conducting shifting in upward, downward, leftward and rightward or deleting by the use of menus displayed by clicking items within a screen of an editable tab with the right side mouse button. Furthermore, there is a method (c) of adding a setting item by the use of menu displayed by clicking items within a screen of a fixed tab with the right side mouse button. In this way, by clicking arbitrary items within setting items, an instruction to edit the whole setting item to which the clicked items belong is conducted.

Here, the editing processing of items to be registered into an editable tab will be explained. The items registered into the editable tab will be displayed on the screen of an editable tab.

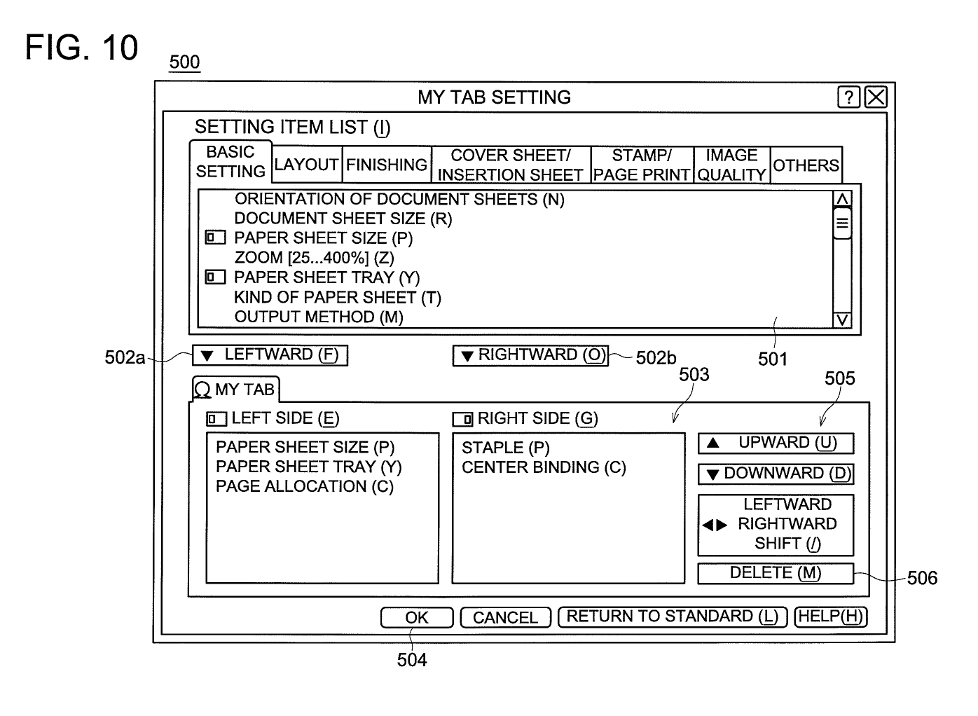

In the method (a), first, an editing screen to edit a screen of an editable tab as shown in FIG. 10 is displayed. On an upper display section 501 of an editing screen 500, with reference to an editable list 400 (FIG. 7), a list of all items which can be displayed on the screen of an editable tab are displayed. The editable list 400 referred to here is a list of parent items each representing a setting item as a group which is composed of plural items and manages a print function, and on the upper display section 501 of FIG. 10, group's parent items are displayed (likewise in the lower display section 503).

Further, on a lower display section 503 of the editing screen 500, a list of items that are actually registered into an editable tab and are displayed on the screen of the editable tab is displayed. In an initial state, items originally registered into the editable tab are displayed on this lower display section 503. It is possible to conduct adding items to be displayed on the screen of an actual editable tab or changing arrangement of items by editing an editable tab.

If an item is selected on the upper display section 501 of the editing screen 500 and a “Leftward” button 502a is pushed, the selected item is added to the left side of the lower display section 503 (in this case, the selected item is added to the left side of the screen of an editable tab). Further, If a “Rightward” button 502b is pushed down, the selected item is added to the right side of the lower display section 503 (in this case, the selected item is added to the right side of the screen of an editable tab). Furthermore, if a “Upward” button, “Downward” button, or “Rightward or leftward shift” button 505 is pushed down, the display position of the item on the screen of an editable tab can be changed. Moreover, if a “Deletion” button 506 is pushed down, a selected item can be deleted from the list of the lower display section 503.

If an “OK” button 504 is pushed down finally, a screen edition instruction is outputted such that indication on the screen of an editable tab is changed in accordance with the information on the lower display section 503.

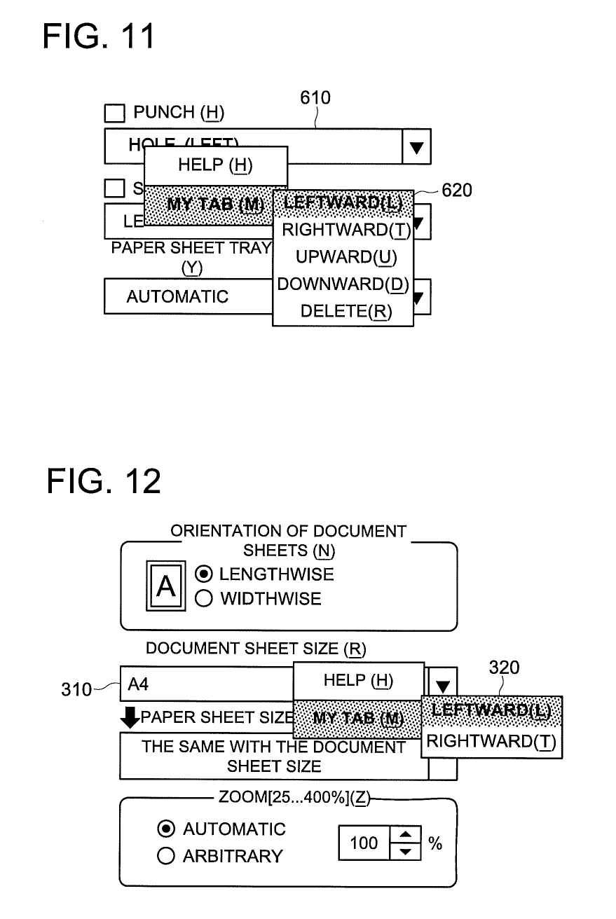

In the method (b), as shown in FIG. 11, an edit of a screen is directly instructed on the screen of an editable tab.

If a right mouse button is clicked on an item 610 being a target of an edit, a menu 620 is displayed. If a user selects one of “Leftward”, “Rightward”, “Upward” and “Downward”, the user can specify that to which side the item is shifted on the screen of an editable tab, and, if “Deletion” is selected, the item can be deleted from the screen of an editable tab.

If a command is issued to an item on this menu 620, first, the group information list 410 (refer to FIG. 8) is referred to. Then, it is investigated that to which group the item belongs, so that an ID of a group's parent item is obtained. Here, as mentioned before, the group information list is a list to administrate a parent item and child items belonging to a group of a function as one unit. That is, in a group, one parent item representing the group and plural child items exist. The reference sign “411” in the group information list 410 shown in FIG. 8 is an example showing one unit of a group in this list. Successively, in accordance with the ID of the obtained parent item and a command from the menu 620, a screen editing instruction is outputted so as to change indication on the screen of an editable tab.

In the method (c), as shown in FIG. 12, an edit of a screen of an editable tab is instructed on a screen of a fixed tab (refer to S106).

A right side mouse button is clicked on an item 310 to be added to a screen of an editable tab among items existing on a screen of a fixed tab, a menu 320 is displayed. If a user selects “Leftward” on the menu, the user can designate to add an item of the target in the left side of a screen of an editable tab, and if a user selects “Rightward” on the menu, the user can designate to add an item of the target in the right side of a screen of an editable tab. The item to be added is added at the rearmost position among items having been already displayed.

If a command is issued to an item on this menu 320, as same as the case of the method (b), the group information list 410 (refer to FIG. 8) is referred to. Then, it is investigated that to which group the item belongs, so that an ID of a group's parent item is obtained. Successively, in accordance with the ID of the obtained parent item and a command from the menu 620, a screen editing instruction is outputted so as to change indication on the screen of an editable tab.

As mentioned above, in this embodiment, user's instructions for edits, such as an addition, shift and deletion, etc. for items displayed on a screen of an editable tab are collectively received for a group unit based on group information being held beforehand.

If a screen editing instruction is issued, as mentioned above, the renewal of a display item list is conducted (S107, S110).

FIG. 13 shows an example of a display item list. This display item list 430a serves also as displace (arrangement) position information on a screen of an editable tab. That is, the display item list functions as a display information holding section which holds display item information about that which items among items held by a fixed tab are displayed on the screen of an editable tab and display position information about display positions of items displayed on a screen of an editable tab.

In the display item list 430a, IDs of parent items each representing a setting item as a group composed of plural items are arranged sequentially from an upper left position on a screen of an editable tab. Items indicated with IDs listed above “−1” in the display item list are arranged on the left side of a screen of an editable tab, and items indicated with IDs listed between “−1” and “0” in the display item list are arranged on the right side of the screen of the editable tab. FIG. 13 shows an arrangement that items of “sheet size”, “sheet feeding tray”, and “page allocation” are displayed in this order on the left side of the screen of the editable tab, and items of “staple” and “center binding” are displayed in this order on the right side of the screen of the editable tab. Indication on the screen of the editable tab is changed in accordance with the information on this display item list. Concretely, child items belonging to the group indicated by a parent item are also processed together with the parent item as one unit. That is, in this embodiment, edits, such as an addition, shift and deletion, etc. for items displayed on a screen of an editable tab are collectively conducted for a group unit based on group information being held beforehand.

After the renewal of a display item list (S107, S110), if the flow is on the condition that a screen of an editable tab is displayed at that time, immediately after that, or if the flow is on the condition that a screen of an fixed tab is displayed at that time, immediately after indication is switched to a screen of an editable tab at the next time, a display processing of the screen of the editable tab is conducted based on the renewed display item list (S108).

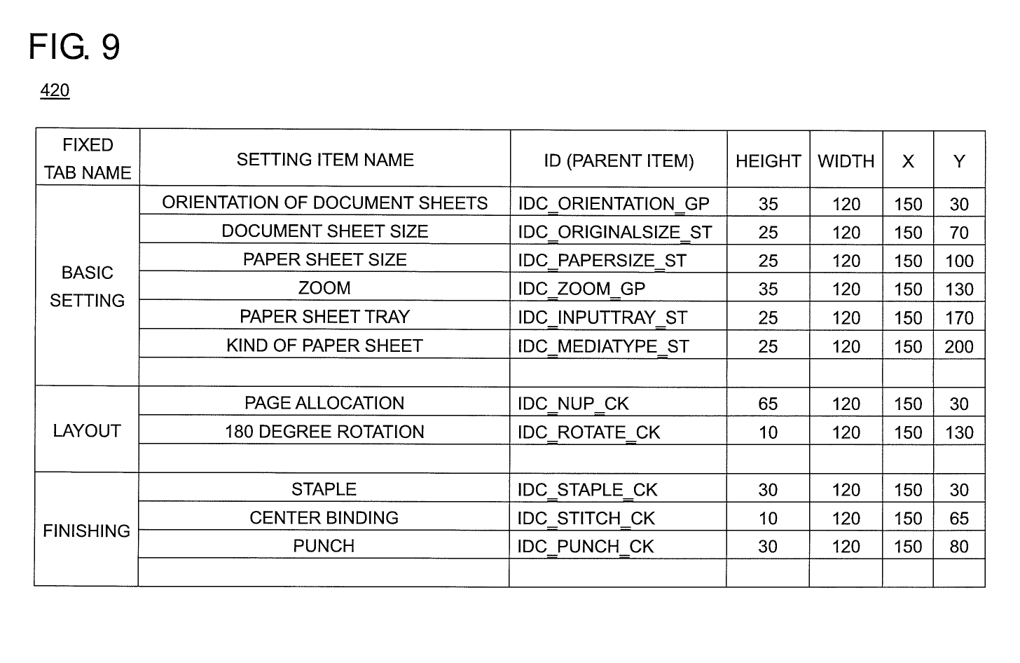

FIG. 9 is a diagram showing the information of each item with a table based on the item information, the editable list, and the group information list that are explained above. In the item information table 420 shown in FIG. 9, “height”, “width”, “X” and “Y” of each setting item in the grouped condition represent coordinate values in the case that each setting item is displayed on a screen of a fixed tab. Hereafter, an explanation is made by the use of the setting item information of FIG. 9.

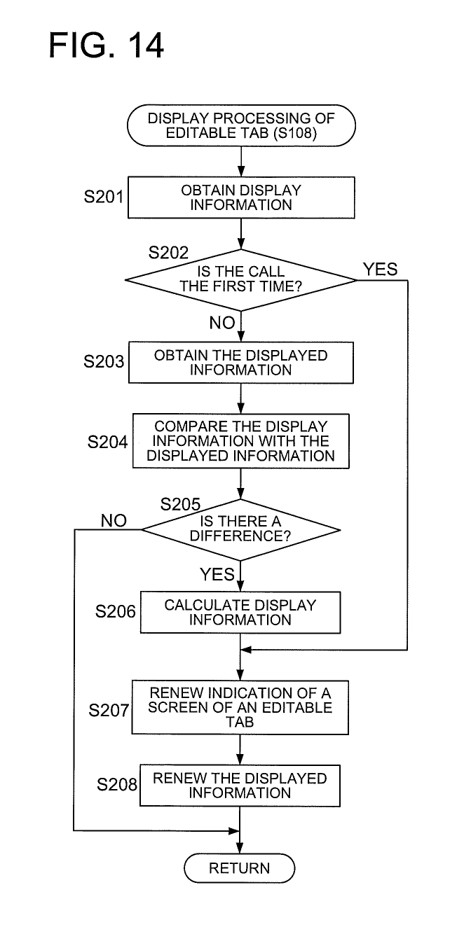

Next, the display processing of a screen of an editable tab will be explained with reference to FIG. 14.

In the display process of a screen of an editable tab, first, the display information of a display item list (refer to FIG. 13) is obtained (S201). Here, the display information includes display item information and display position information.

Successively, it is judged that whether the call of this processing shown in FIG. 14 is the first time (S202). When it is the first call (S202: YES), the flow proceeds to Step S207, and a screen of an editable tab is displayed in accordance with the display information of the display item list. Here, a control to indicate an item correctively by a group unit on a screen of an editable tab is conducted.

In this embodiment, assumed is the case where the condition of the display item list 430a shown in FIG. 13 is displayed by the first call.

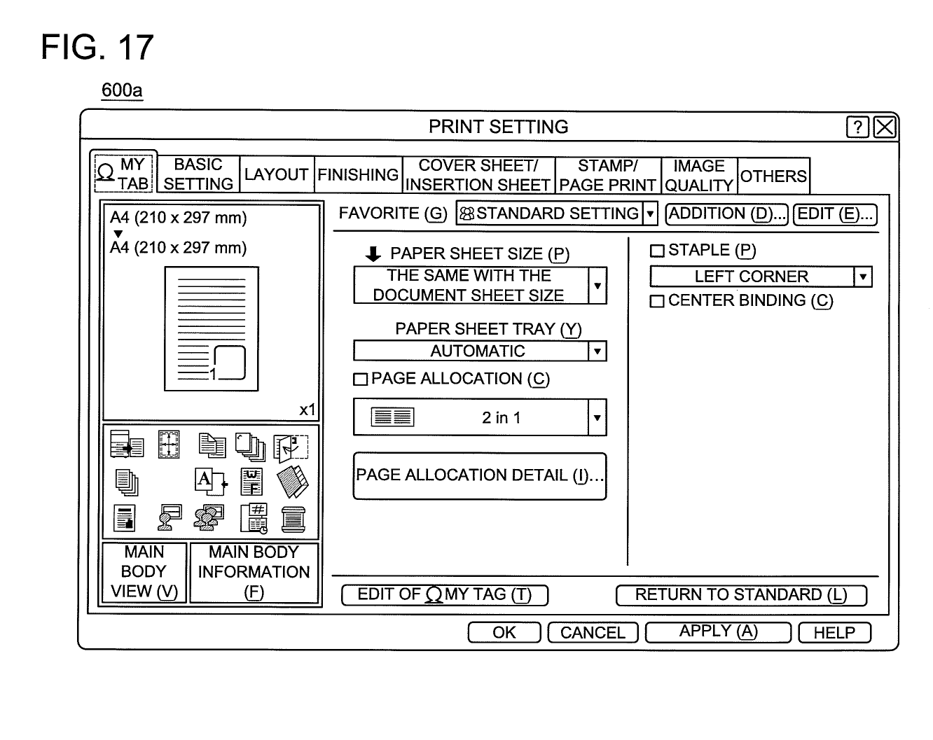

FIG. 17 shows an example of a screen 600a of an editable tab that displays the condition of the display item list 430a shown in FIG. 13.

On the other hand, when the call is the second time or later (5202: NO), displayed information of a displayed information table being held in a displayed information holding section 111 is obtained (S203).

The displayed information table is a table of information about items having been displayed on a screen of an editable tab. That is, the displayed information table is a table having the displayed information about that which items are displayed on which positions on a screen of an editable tab. This displayed information table is produced when a screen of an editable tab is displayed (5207).

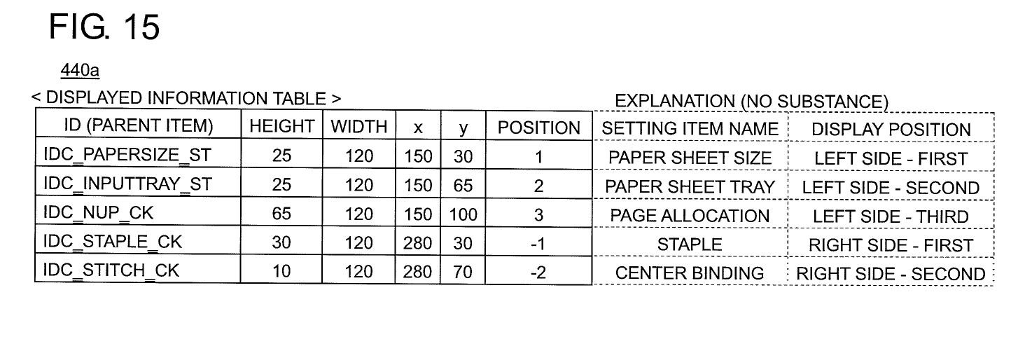

FIG. 15 is a diagram showing an example of the displayed information table. The displayed information of the displayed information table 440a includes, concretely, an ID of a parent item representing a group composed of plural items being structural elements of setting items displayed on a screen of an editable tab and information about a vertical length and a horizontal length (height, width) of the whole of the group, display position coordinates (x, y), and display order.

Then, the displayed information obtained at Step S203 is compared with the display information obtained at Step S201 (S204).

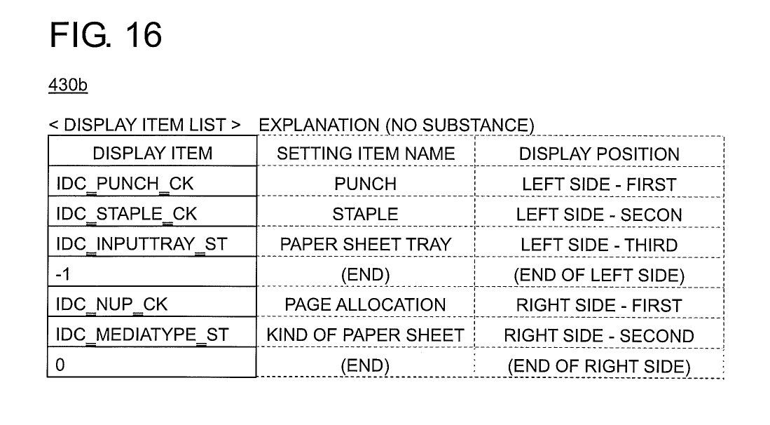

Here, the case where the condition of the display item list 430b shown in FIG. 16 is displayed by the second call is assumed. In this case, at Step S201, the display information of the display item list 430b is obtained.

At Step S205, it is judged that whether there is any difference between the displayed information and the display information.

In the case that it is judged at step S205 that there is no difference (S205: NO), is judged that it is not necessary to renew a screen of an editable tab, and the processing shown in FIG. 14 ends and the processing flow returns to the flowchart shown in FIG. 4.

On the other hand, in the case that it is judged that there is a difference at step S205 (S205: YES), the display information to reflect the difference in a screen is calculate (S206). Concretely, with reference to the display information of a display item list (FIG. 16), the group information of a group information list (FIG. 8), the setting item information of an item information table (FIG. 9), and the item information (FIG. 5) of a fixed tab, the display positions of a parent item and child items are calculated. Successively, in accordance with the display information calculated at Step S206, the renewal of indication of a screen of an editable tab is conducted (S207). Here, in the case that an edit is conducted about items displayed on a screen of an editable tab, also a control to display the item correctively on a screen of an editable tab by a group unit is conducted.

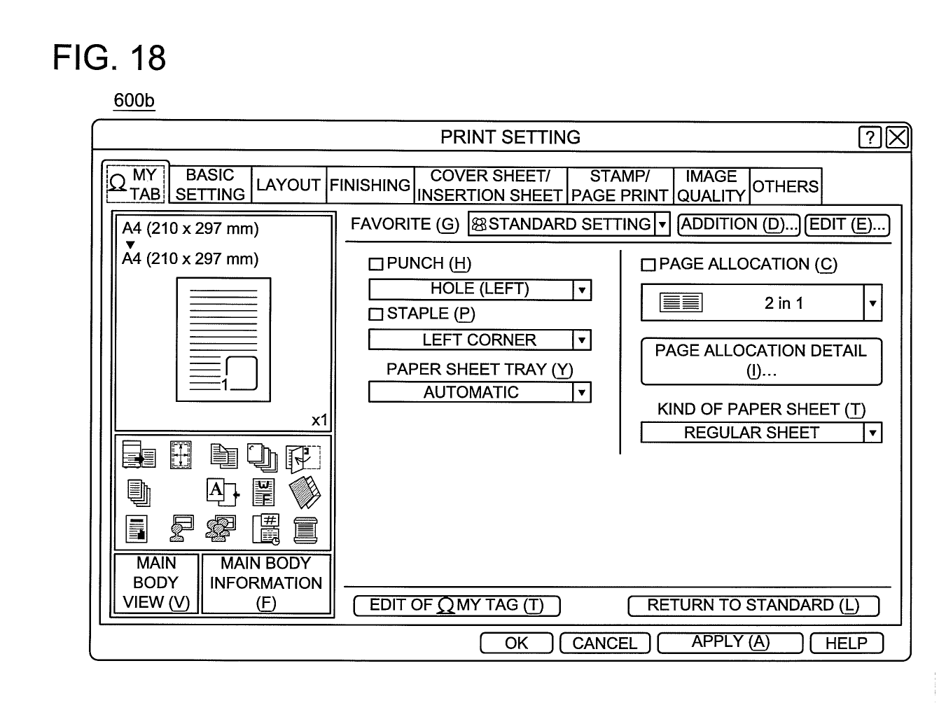

FIG. 18 shows an example of a screen 600b of a editable tab which displays the condition where an edit has been made into the display item list 430b shown in FIG. 16 after displaying the condition of the display item list 430a shown in FIG. 13.

After the renewal of a screen of an editable tab has been completed, the displayed information of the displayed information table is renewed (S208), the processing of FIG. 14 ends and the processing flow returns to the flowchart shown in FIG. 4.

As explained above, in this embodiment, an edit about items displayed on a screen of a tab is conducted. Then, a control to display items correctively by a group unit on a screen of a tab selected by a user is conducted in accordance with group information about that to which group each item belongs, by the use of item information about indication of the items of a tab holding plural items. More concretely, addition, shift and deletion of items displayed on a screen of a tab selected by a user is conducted correctively by a group unit.

In this way, according to the present invention, it becomes possible to conduct a processing about indication of an item by a group unit that makes a meaning. With this, it is possible to prevent that the items as structural elements of a setting item controlling one function are treated separately. Therefore, it becomes possible to avoid the situation where an item incapable of constituting a meaningful function from a simple body exists on a screen independently.

Further, in this embodiment, when an editable tab displayed selectively together with a fixed tab is selected by the user, a screen of the editable tab is produced and displayed by the use of the display item information about that which items are displayed on the screen of the editable tab, the display position information about the display position of the items displayed on the screen of the editable tab, and the item information held by the fixed tab. Therefore, while preventing the situation that the location of an item is lost with the shift of the item of a setting target from one screed to another screen, it becomes possible to display a screen of an editable tab, which has editable items and is displayed selectively together with a fixed tab, by easy operations without giving a user an uncomfortable feeling. As a result, an operation time and operation failures of a user in setting work of an item can be reduced.

Further, in this embodiment, instructions of a user to edit items displayed on a screen of a tab are received collectively by a group unit. For example, if an arbitrary item in a setting item is clicked, an edit of the whole of a setting item to which the clicked item belongs, are instructed. Therefore, a user can instruct easily and certainly processing with regard to indication of an item by a group unit which constitutes a meaning.

The present invention is not limited only to the above-mentioned embodiments and can be changed variously.

For example, in the above-mentioned embodiments, both the display item information about that which items of the items held by a fixed tab are displayed on a screen of an editable tab and the display position information about the display positions of the items to be displayed on a screen of an editable tab are held in the display item list. However, the present invention is not limited to the above-mentioned embodiments, the display item information and the display position information may be held in respective separate storage regions.

Moreover, in the above-mentioned embodiments, the item setting apparatus for conducting setting for items to set printing conditions based on a user's operation has been explained, the present invention is not limited to these embodiments. The present invention can be applied also to, for example, an item setting apparatus for conducting setting for items to set conditions of other services based on a user's operation.

The device and method for performing various kinds of processing in the item setting apparatus of the present embodiments can be realized with hardware circuitry for exclusive use or a programmed computer. The above programs may be provided, for example, by record medium readable by a computer, such as a flexible disk and a CD-ROM, or may be provided online through networks, such as an Internet. In this case, the programs recorded in the record medium readable by a computer are usually transmitted to storage sections, such as a hard disk, and are memorized. Moreover, the programs may be provided as independent application software, or may be incorporated in the software of an apparatus as one function of an item setting apparatus.

The abovementioned embodiments can be summarized into the following technical features.

(1) An item setting apparatus for conducting setting based on a user's operation for items displayed on a screen capable of being changed over by selecting a desired tab from plural tabs, comprises:

an item information holding section to hold item information about indication of an item of a tab having plural items;

a group information holding section to hold group information about that to which group each item belongs;

a display item editing section to edit an item displayed on a screen of a tab; and

a tab display control section to control to display items correctively by a group unit on a screen of a tab selected by a user by using the item information.

(2) The item setting apparatus described in the above (1) is characterized in that the above-mentioned item information holding section holds item information about indication of items of a fixed tab holding fixed items; the item setting apparatus further comprises a display information holding section for holding a display item information about that which item of the items held by the fixed tab is to be displayed on a screen of an editable tab in which holding items can be edited and display position information about display positions of the items to be displayed on the screen of the editable tab; the display item editing section conducts editing for the items displayed on the screen of the editable tab, and the tab display control section comprises a fixed tab display control section to control to display correctively items by a group unit on a screen of a fixed tab selected by a user by using the item information of the fixed tab and an editable tab display control section to control correctively items by a group unit on a screen of an editable tab selected by a user by using the display item information, the display position information and the item information of the fixed tab.
(3) The item setting apparatus described in the above (1) or (2) is characterized in that the tab display control section conducts adding, shifting or deleting for items displayed on the screen of the tab selected by the user correctively by a group unit.
(4) The item setting apparatus described in any one of the above (1) to (3) is characterized by further comprising a screen edit instructing section to receive instructions by a user for an edit of the items displayed on the screen of the tab collectively by the group unit.
(5) The item setting apparatus described in any one of the above (1) to (4) is characterized in that the items are items to set a printing condition.
(6) A control program of an item setting apparatus for conducting setting based on a user's operation for items displayed on a screen capable of being changed over by selecting a desired tab from plural tabs, the control program making the item setting apparatus execute procedures comprising:

a procedure (a) for conducting editing for items to be displayed on a screen of the tab;

a procedure (b) for conducting a control to display items correctively by a group unit on a screen of a tab selected by a user in accordance with group information held by a group information holding section to hold the group information about that to which group each item belongs, by using item information held by an item information holding section to hold the item information about indication of an item of a tab having plural items.

(7) The control program described in the above item (6) is characterized in that the above-mentioned item information holding section holds item information about indication of items of a fixed tab holding fixed items; in the procedure (a), editing is conducted for items displayed on a screen of an editable tab capable of editing holding items; and the procedure (b) comprises a procedure (b1) of conducting a control to display items correctively by a group unit on a screen of a fixed tab selected by a user by using the item information of the fixed tab and a procedure (b2) of conducting a control to display items correctively by a group unit on a screen of an editable tab selected by a user by using display item information and display position information held by a display information holding section to hold the display item information about that which item among items held by the fixed tab is to be displayed on a screen of the editable tab, and the display item information about display positions of items to be displayed on a screen of the editable tab, and the item information of the fixed tab.
(8) The control program described in the above (6) or (7) is characterized in that in the procedure (b), adding, shifting or deleting for the items displayed on the screen of the tab selected by the user is conducted correctively by a group unit.
(9) The control program described in any one of the above (6) to (8) is characterized by making the item setting apparatus execute further a procedure (C) of receiving collectively instructions of an edit by a user for items to be displayed on the screen of the tab by the group unit.
(10) The control program described in any one of the above (6) to (9) is characterized in that the items are items to set printing conditions.
(11) A recording medium readable by a computer, recording the control program described in any one of the above (6) to (10).
(12) A control method of an item setting apparatus for conducting setting based on a user's operation for items displayed on a screen capable of being changed over by selecting a desired tab from plural tabs, comprising:

a step (a) for conducting editing for items to be displayed on a screen of the tab;

a step (b) for conducting a control to display items correctively by a group unit on a screen of a tab selected by a user in accordance with group information held by a group information holding section to hold group information about that to which group each item belongs, by using item information held by an item information holding section to hold item information about indication of an item of a tab having plural items.

(13) The control method described in the above (12) is characterized in that the above-mentioned item information holding section holds item information about indication of items of a fixed tab holding fixed items; in the step (a), editing is conducted for items displayed on a screen of an editable tab capable of editing holding items; and the step (b) comprises a step (b1) of conducting a control to display items correctively by a group unit on a screen of a fixed tab selected by a user by using the item information of the fixed tab and a step (b2) of conducting a control to display items correctively by a group unit on a screen of an editable tab selected by a user by using display item information and display position information held by a display information holding section to hold the display item information about that which item among items held by the fixed tab is to be displayed on a screen of the editable tab, and the display item information about display positions of items to be displayed on a screen of the editable tab, and the item information of the fixed tab.
(14) The control method described in the above (12) or (13) is characterized in that adding, shifting or deleting items to be displayed on the screen of the tab selected by the user is conducted correctively by a group unit.
(15) The control method described in any one of the above (12) to (14) is characterized by further comprising a step (C) of receiving collectively instructions of an edit by a user for items to be displayed on the screen of the tab by the group unit.
(16) The control method described in any one of the above (12) to (15) is characterized in that the items are items to set printing conditions.

In the present invention, an edit for items to be displayed on a screen of a tab is performed. Further, a control to display items correctively by a group unit on a screen of a tab selected by a user is conducted in accordance with group information about that to which group each item belongs, by using item information about indication of an item of a tab having plural items.

In this way, according to the present invention, it becomes possible to perform processing about indication of an item by a group unit that constitutes a meaning. With this, it is possible to prevent items as structural elements of an setting item to manage one function from being handled separately respectively. Therefore, it is possible to avoid a situation where an item that cannot constitute a meaningful function with its simple body exists on a screen independently.

What is claimed is:

1. An item setting apparatus for changing over a screen corresponding to a desired tab by selecting the desired tab from plural tabs and setting items displayed on the screen based on a user's operation, comprising:
an item information holding section to hold item information about indication of items of plural tabs having plural items;
a group information holding section to separate items into plural groups and hold group information about that to which group each item belongs;
a display item editing section to edit items displayed on a screen of a tab; and
a tab display control section to control to display items correctively by a group unit on a screen of a tab selected by a user by using the group information.

2. The item setting apparatus described in claim 1, wherein the item setting apparatus has a fixed tab including fixed items and an editable tab including editable items as the plural tabs, and the item setting apparatus further comprises a display information holding section to hold display item information about that which item of the items held by the fixed tab is to be displayed on a screen of the editable tab and display position information about display positions of the items to be displayed on the screen of the editable tab.

3. The item setting apparatus described in claim 2, wherein the item information holding section holds item information about indication of items of the fixed tab holding fixed items, and the display item editing section conduct editing for the items displayed on the screen of the editable tab.

4. The item setting apparatus described in claim 2, wherein the tab display control section comprises a fixed tab display control section to control to display correctively items by a group unit on a screen of a fixed tab selected by a user by using the item information of the fixed tab and the group information and an editable tab display control section to control correctively items by a group unit on a screen of an editable tab selected by a user by using the display item information, the display position information, the item information of the fixed tab, and the group information.

5. The item setting apparatus described in claim 1, wherein the tab display control section conducts adding, shifting or deleting for items displayed on the screen of the tab selected by the user correctively by a group unit.

6. The item setting apparatus described in claim 1, further comprising a screen edit instructing section to receive instructions from a user for an edit of the items displayed on the screen of the tab collectively by the group unit.

7. The item setting apparatus described in claim 1, wherein the items are items to set a printing condition.

8. A recording medium readable by a computer and for storing a control program of an item setting apparatus for changing over a screen corresponding to a desired tab by selecting the desired tab from plural tabs and setting items displayed on the screen based on a user's operation, the control program making the item setting apparatus execute procedures comprising:
a procedure (a) of conducting editing for items displayed on a screen of the tab;
a procedure (b) of conducting a control to display items correctively by a group unit on a screen of a tab selected by a user in accordance with group information held by a group information holding section to hold the group information about that to which group each item belongs, by using item information held by an item information holding section to hold the item information about indication of items of a tab having plural items.

9. The recording medium described in claim 8, wherein the plural tabs includes a fixed tab having fixed items and a editable tab having editable items;
in the procedure (a), editing is conducted for items displayed on a screen of the editable tab; and
the procedure (b) comprises:
a procedure (b1) of conducting a control to display items correctively by a group unit on a screen of the fixed tab selected by a user by using the item information of the fixed tab and the group information, and
a procedure (b2) of conducting a control to display items correctively by a group unit on a screen of the editable tab selected by a user by using display item information, display position information, the item information of the fixed tab and the group information, wherein the display item information and the display position information are held by a display information holding section, the display item information is information about that which items among items held by the fixed tab are to be displayed on a screen of the editable tab, and the display position information is information about display positions of the items to be displayed on the screen of the editable tab.

10. The recording medium described in claim 8, wherein in the procedure (b), adding, shifting or deleting for the items displayed on the screen of the tab selected by the user is conducted correctively by a group unit.

11. The recording medium described in claim 8, further comprising:
a procedure (C) of receiving instructions from a user for an edit of the items displayed on the screen of the tab collectively by the group unit.

12. The recording medium described in claim 8, wherein the items are items to set a printing condition.

13. A method of an item setting apparatus for changing over a screen corresponding to a desired tab by selecting the desired tab from plural tabs and setting items displayed on the screen based on a user's operation, the method comprising:
a step (a) of conducting editing for items displayed on a screen of the tab;
a step (b) of conducting a control to display items correctively by a group unit on a screen of a tab selected by a user in accordance with group information held by a group information holding section to hold the group information about that to which group each item belongs, by using item information held by an item information holding section to hold the item information about indication of items of a tab having plural items.

14. The method described in claim 13, wherein the plural tabs includes a fixed tab having fixed items and a editable tab having editable items;
in the step (a), editing is conducted for items displayed on a screen of the editable tab; and
the step (b) comprises:
a step (b1) of conducting a control to display items correctively by a group unit on a screen of the fixed tab selected by a user by using the item information of the fixed tab and the group information, and
a step (b2) of conducting a control to display items correctively by a group unit on a screen of the editable tab selected by a user by using display item information, display position information, the item information of the fixed tab and the group information, wherein the display item information and the display position information are held by a display information holding section, the display item information is information about that which items among items held by the fixed tab are to be displayed on a screen of the editable tab, and the display position information is information about display positions of the items to be displayed on the screen of the editable tab.

15. The method described in claim 13, wherein in the step (b), adding, shifting or deleting for the items displayed on the screen of the tab selected by the user is conducted correctively by a group unit.

16. The method described in claim 13, further comprising:
a step (C) of receiving instructions from a user for an edit of the items displayed on the screen of the tab collectively by the group unit.

17. The method described in claim 13, wherein the items are items to set a printing condition.
